(19) United States
(12) Patent Application Publication
(10) Pub. No.: US 2007/0192161 A1
(43) Pub. Date: Aug. 16, 2007

(54) On-demand customer satisfaction measurement

(75) Inventors: Sandra L. Kogan, Newton, MA (US); Michael Muller, Medford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/320,028

(22) Filed: Dec. 28, 2005

(51) Int. Cl. G06F 17/30

(52) U.S. Cl. 705/10

(57) ABSTRACT

Embodiments of the present invention address deficiencies of the art in respect to customer relationship management and provide a method, system and computer program product for on-demand customer satisfaction measurement. In one embodiment of the invention, an on-demand customer satisfaction measurement method can include matching a target profile to a usage profile to determine whether an associated end user is to receive an abbreviated survey, forwarding the abbreviated survey to the end user only if the target profile and usage profile match, and collecting survey results for the abbreviated survey. The method further can include monitoring application usage for the end user in an end user client computing device, constructing the usage profile based upon the monitored application usage, and storing the usage profile in the client computing device.

[symbol] surveys require a substantial number of focused questions, surveys can consume a significant amount of time to complete. In consequence, customers can become impatient with customer satisfaction surveys, and in many cases can refuse to cooperate in providing customer feedback through a survey.

Survey follow up is an important aspect customer relationship management. For many completed surveys, it can be advantageous to directly contact a survey participant to address particular issues not readily addressable through standardized survey questions. Yet, for many survey participants, anonymity is of paramount importance and, as such, survey participants are not eager to provide personal identifying information in completing a survey. Without personal identifying information, though, survey follow up is not possible. Accordingly, the effectiveness of a survey can be limited to the generic nature of responses to standardized, un-personalized questions.

A “moment of truth” is defined as an event that brings a vendor to the mind of a consumer. Moments of truth include the individual, indirect customer interactions with a product or service whereby an opinion can be formed of the vendor by the consumer following the interaction. It is well-known that focusing on moments of truth can have a substantial impact on the customer service relationship with consumers in the marketplace. Notwithstanding, traditional survey data collection techniques occur too infrequently to capture moments of truth for a vendor. Accordingly, conventional customer relationship management cannot capitalize on feedback related to moments of truth.

### BRIEF SUMMARY OF THE INVENTION

Embodiments of the present invention address deficiencies of the art in respect to customer relationship management and provide a novel and non-obvious method, system and computer program product for on-demand customer satisfaction measurement. In one embodiment of the invention, an on-demand customer satisfaction measurement method can include matching a target profile to a usage profile to determine whether an associated end user is to receive an abbreviated survey, forwarding the abbreviated survey to the end user only if the target profile and usage profile match, and collecting survey results for the abbreviated survey. The method further can include monitoring application usage for the end user in an end user client computing device, constructing the usage profile based upon the monitored application usage, and storing the usage profile in the client computing device.

In one aspect of the embodiment, the method further can include detecting a moment of truth for the end user, and, responsive to detecting the moment of truth, performing the matching, forwarding and collecting steps. In another aspect of the embodiment, the method further can include providing a reward to the end user for responding to the abbreviated survey. Providing a reward to the end user for responding to the abbreviated survey can include determining whether the end user has responded to a threshold number of abbreviated surveys, and providing the reward only of the end user has responded to a threshold number of abbreviated surveys. Alternatively, providing a reward to the end user for responding to the abbreviated survey can include receiving a request for a reward from the end user for having responded to the abbreviated survey.

In another embodiment of the invention, a customer relationship management data processing configured for on-demand customer satisfaction measurement can be provided. The system can include an application host configured for hosting at least one application, and survey logic coupled to the application host and a data store of survey results. The survey logic can include program code enabled to provide an abbreviated survey to an end user only if a target profile for the abbreviated survey matches a usage profile for the end user. In one aspect of the embodiment, the system further can include moment of truth detection logic coupled to the survey logic. In another aspect of the embodiment, reward processing logic can be coupled to the survey logic.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a customer relationship management data processing configured for on-demand customer satisfaction measurement; and,

FIGS. 2A and 2B, taken together, are a flow chart illustrating a process for on-demand customer satisfaction measurement.

### DETAILED DESCRIPTION OF THE INVENTION

Embodiments of the present invention provide a method, system and computer program product for on-demand customer satisfaction measurement. In accordance with an embodiment of the present invention, interactions between a consumer and a computer program can be monitored and a usage profile can be constructed for the consumer based upon the interactions. The usage profile can be stored locally and privately for the benefit of the consumer. Subsequently, an on-demand survey can be composed for a target profile and the target profile can be compared to the usage profile. Where a match occurs, the on-demand survey can be provided to the client and the responses to the survey can be returned in short course. Notably, the on-demand survey can be provided responsive to the detection of a moment of truth in the computer program.

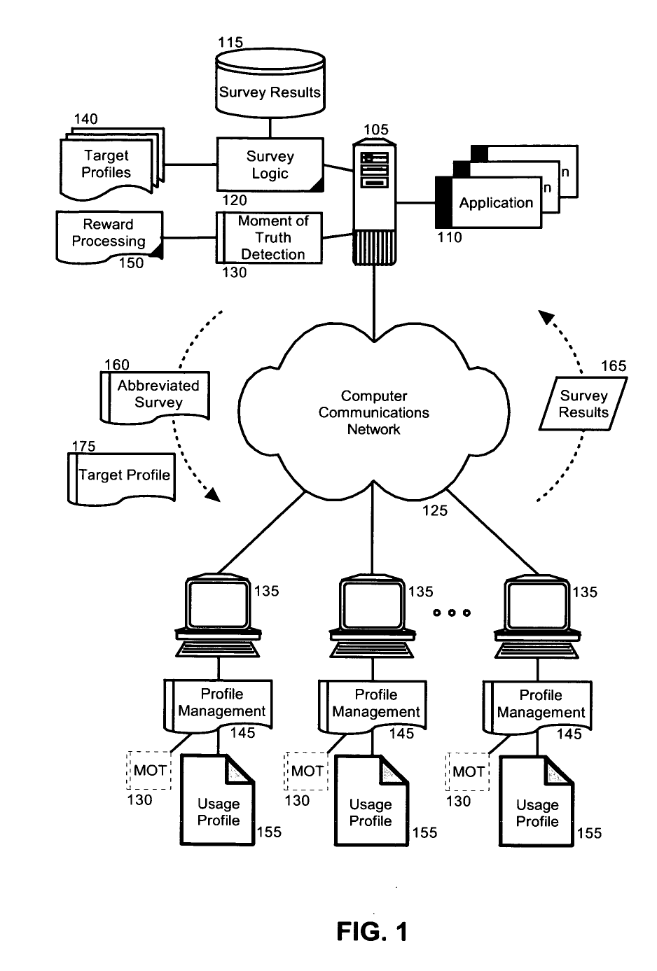

In further illustration of an embodiment of the invention, FIG. 1 is a schematic illustration of a customer relationship management data processing configured for on-demand customer satisfaction measurement. The data processing system can include an application host 105 supporting the execution of one or more applications 110 accessed by end users through one or more client computing devices 135 over computer communications network 125. In one aspect of the invention, the applications 110 can include portlet applications provided through a portal view accessed in the client computing devices 135.

Survey logic 120 can be coupled to the application host 105 and can include program code enabled to conduct an abbreviated survey 160 with the client computing devices 135. The program code of the survey logic 120 further can be enabled to acquire survey results 165 responsive to the abbreviated survey 160 from the client computing devices 135 for collection in a data store of survey results 115. Specifically, the abbreviated survey 160 can be a limited survey of only a few questions which provide for a quantitative, on-demand evaluation. Notably, the program code of the survey logic 120 can be enabled to limit the conduct of the abbreviated survey 160 to only selected ones of the client computing devices 135 having a usage profile 155 which compares to a particular target profile 140 established for the abbreviated survey 160.

More specifically, each of the client computing devices 135 can include profile management logic 145 including program code enabled to monitor application usage within respective ones of the client computing devices 135. Based upon the monitored application usage, a usage profile 155 can be created by the program code of the profile management logic 145 for a corresponding end user. In this way, only those end users of the client computing devices 135 having a usage profile 155 which matches that of a specified target profile 140 can be prompted to complete the abbreviated survey 160. The remaining end users needn't be bothered with completing the abbreviated survey 160. Importantly, in a preferred aspect of the invention, the matching can be performed in the client computing devices 135 based upon a target profile 175 provided by the program code of the survey logic 120.

Importantly, moment of truth detection logic 130 further can be coupled to the application host 105. Optionally, the moment of truth detection logic 130 can be coupled to the client computing devices 135 in order to preserve privacy. Regardless, the moment of truth detection logic 130 can include program code enabled to detect moments of truth in one or more of the applications 110 for one or more end users of the client computing devices 135. In this regard, a moment of truth can be detected based upon the interaction of the end users of the client computing devices 135 with one or more user interface elements of, or logical operations provided by the applications 110. As such, the program code of the moment of truth logic 130 can be enabled to respond to the detection of a moment of truth by providing an abbreviated survey 160 for to an end user having a suitable usage profile 155. In this way, immediate feedback can be obtained from the end user based upon the moment of truth experience.

Finally, the system can include reward processing logic 150. The reward processing logic 150 can include program code enabled for awarding end users who respond to the abbreviated survey 160 and provide survey results. For instance, when an end user has answered a sufficient number of surveys, an associated one of the client computing devices 135 can send an encrypted award-qualification notice to the reward processing logic 150 which, in turn, can forward an award to the end user. Notably, as the message from the associated one of the client computing devices 135 is separate from the survey results 165, the end user can receive an award without revealing personal data.

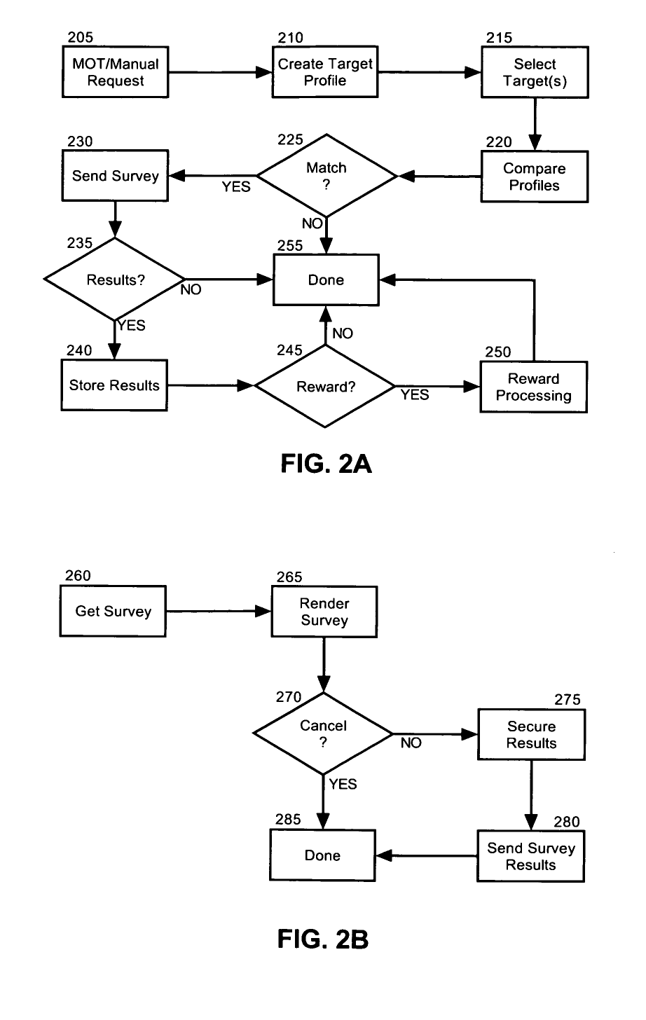

In even yet further illustration, FIGS. 2A and 2B, taken together, are a flow chart illustrating a process for on-demand customer satisfaction measurement. Turning first to FIG. 2A, in block 205, a moment of truth can be detected responsive to which an abbreviated survey is to be provided. Alternatively, a manual request for an abbreviated survey can be received. In either case, in block 210 a target profile can be created for the abbreviated survey and in block 215, one or more target end users can be selected to receive the abbreviated survey. In block 220, the usage profiles for the target end users can be compared to the target profile.

In decision block 225, if the profiles match, the process can continue through block 230. In block 230, an abbreviated survey can be sent to each target end user having a usage profile which matches the target profile. In decision block 235, if survey results are received from an end user, in block 240 the survey results 240 can be stored. Finally, in decision block 245, if the end user is entitled to an award for having responded to a threshold number of abbreviated surveys, in block 250, a request for an award can be processed and the process can end in block 255.

Turning now to FIG. 2B, in block 260, an abbreviated survey can be received for processing. In block 265, the abbreviated survey can be rendered, for instance in a dialog box. Subsequently, in decision block 270, it can be determined whether the end user has provided survey results, or whether the end user has declined to submit survey results. If the end user has provided survey results, in block 275 the results can be secured, for example encrypted. Once encrypted, the survey results can be forwarded to the survey logic in block 280. Finally, the process can end in block 285.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An on-demand customer satisfaction measurement method comprising:
publishing a target profile for end users to receive an abbreviated survey;
matching the target profile to a usage profile to determine whether an associated end user is to receive an abbreviated survey;
forwarding the abbreviated survey to the end user only if the target profile and usage profile match; and,
collecting survey results for the abbreviated survey.

2. The method of claim 1, further comprising:
monitoring application usage for the end user in an end user client computing device;
constructing the usage profile based upon the monitored application usage; and,
storing the usage profile in the client computing device.

3. The method of claim 1, wherein matching the target profile to a usage profile to determine whether an associated end user is to receive an abbreviated survey, comprises matching the target profile to a usage profile within a client computing device to determine whether an associated end user is to receive an abbreviated survey.

4. The method of claim 1, further comprising:
detecting a moment of truth for the end user; and,
responsive to detecting the moment of truth, performing the matching, forwarding and collecting steps.

5. The method of claim 4, wherein detecting a moment of truth for the end user, comprises detecting a moment of truth for the end user in a client computing device.

6. The method of claim 1, further comprising providing a reward to the end user for responding to the abbreviated survey.

7. The method of claim 6, wherein providing a reward to the end user for responding to the abbreviated survey comprises:
determining whether the end user has responded to a threshold number of abbreviated surveys; and,
providing the reward only of the end user has responded to a threshold number of abbreviated surveys.

8. The method of claim 6, wherein providing a reward to the end user for responding to the abbreviated survey comprises receiving a request for a reward from the end user for having responded to the abbreviated survey.

9. The method of claim 1, wherein collecting survey results for the abbreviated survey, comprises collecting an encrypted form of the survey results for the abbreviated survey.

10. A customer relationship management data processing configured for on-demand customer satisfaction measurement, the system comprising:
an application host configured for hosting at least one application; and,
survey logic coupled to the application host and a data store of survey results;
the survey logic comprising program code enabled to provide an abbreviated survey to an end user only if a target profile for the abbreviated survey matches a usage profile for the end user.

11. The system of claim 10, wherein the application host is a portlet application.

12. The system of claim 10, further comprising moment of truth detection logic coupled to the survey logic.

13. The system of claim 10, further comprising moment of truth detection logic coupled to a client computing device communicatively linked to the application host.

14. The system of claim 10, further comprising reward processing logic coupled to the survey logic.

15. A computer program product comprising a computer usable medium having computer usable program code for on-demand customer satisfaction measurement, said computer program product including:
computer usable program code for publishing a target profile of end users to receive an abbreviated survey;
computer usable program code for matching the target profile to a usage profile to determine whether an associated end user is to receive an abbreviated survey;
computer usable program code for forwarding the abbreviated survey to the end user only if the target profile and usage profile match; and,
computer usable program code for collecting survey results for the abbreviated survey.

16. The computer program product of claim 15, further comprising:
computer usable program code for monitoring application usage for the end user in an end user client computing device;
computer usable program code for constructing the usage profile based upon the monitored application usage; and,
computer usable program code for storing the usage profile in the client computing device.

17. The computer program product of claim 15, wherein the computer usable program code for matching the target profile to a usage profile to determine whether an associated end user is to receive an abbreviated survey, comprises computer usable program code for matching the target profile to a usage profile within a client computing device to determine whether an associated end user is to receive an abbreviated survey.

18. The computer program product of claim 15, further comprising:
computer usable program code for detecting a moment of truth for the end user; and,
computer usable program code for responsive to detecting the moment of truth, performing the matching, forwarding and collecting steps.

19. The computer program product of claim 18, wherein the computer usable code for detecting a moment of truth for the end user, comprises computer usable program code for detecting a moment of truth for the end user in a client computing device.

20. The computer program product of claim 15, further comprising computer usable program code for providing a reward to the end user for responding to the abbreviated survey.

21. The computer program product of claim 20, wherein the computer usable program code for providing a reward to the end user for responding to the abbreviated survey comprises:
computer usable program code for determining whether the end user has responded to a threshold number of abbreviated surveys; and,
computer usable program code for providing the reward only of the end user has responded to a threshold number of abbreviated surveys.

22. The computer program product of claim 20, wherein the computer usable program code for providing a reward to the end user for responding to the abbreviated survey comprises computer usable program code for receiving a request for a reward from the end user for having responded to the abbreviated survey.

23. The computer program product of claim 15, wherein the computer usable program code for collecting survey results for the abbreviated survey, comprises computer usable program code for collecting an encrypted form of the survey results for the abbreviated survey.
